(19) United States
(12) Patent Application Publication
(10) Pub. No.: US 2023/0067669 A1
(43) Pub. Date: Mar. 2, 2023

(54) IMAGING DEVICE

(71) Applicant: NIDEC COPAL CORPORATION, Tokyo (JP)

(72) Inventors: Yusuke AKAMATSU, Tokyo (JP); Yuusuke SUZUKI, Tokyo (JP)

(21) Appl. No.: 17/896,080

(22) Filed: Aug. 26, 2022

(30) Foreign Application Priority Data
Aug. 30, 2021 (JP) 2021-139523

(51) Int. Cl. H04N 5/235

(52) U.S. Cl. CPC H04N 5/2351; H04N 5/2352

(57) ABSTRACT

An imaging device performs imaging in a dark surrounding environment, while protecting the privacy of a subject. An imaging device includes an image processor that receives subject light from a subject passing through an opening, converts the subject light to an image signal, and amplifies the image signal to generate image data, a lens cover between the opening and an imaging element to cover the opening to restrict the subject light from entering the imaging element, an illumination light source that emits illumination light to illuminate the subject, and a switch including a first filter allowing no entry of the illumination light into the imaging element and a second filter allowing entry of the illumination light into the imaging element. The switch places one of the first filter or the second filter between the imaging element and the opening based on a brightness of a surrounding environment.

### RELATED APPLICATIONS

The present application claims priority to Japanese Application Number 2021-139523, filed Aug. 30, 2021, the disclosure of which is hereby incorporated by reference herein in its entirety.

### BACKGROUND

### Technical Field

The present invention relates to an imaging device.

### Description of the Background

Surveillance cameras are installed in various places such as nursing facilities, hospitals, factories, and stores for crime and disaster prevention. A surveillance camera that is an imaging device may be installed in an environment in which the surroundings of the camera can be darker at night than during the day, causing difficulty in surveillance. A known surveillance camera may be used with an auxiliary illumination device that is turned on to illuminate an object to be monitored with infrared light in response to dark surroundings and stops using infrared light for image capturing with visible light in response to bright surroundings.

Patent Literature 1 describes a surveillance camera that determines the brightness of a subject and controls the timing for turning on and off the auxiliary illumination device as well as the amount of light when the auxiliary illumination device is turned on.

### CITATION LIST

### Patent Literature

Patent Literature 1: Japanese Unexamined Patent Application Publication No. 2013-126037

### BRIEF SUMMARY

A surveillance camera that uses such auxiliary illumination is also to be operated with privacy protection of an individual as a subject.

An imaging device according to an aspect of the present invention includes an imaging unit that receives subject light from a subject passing through an opening, converts the subject light to an image signal, and amplifies the image signal to generate image data, a light shield between the opening and the imaging unit to cover the opening to restrict the subject light from entering the imaging unit, an illumination light source that emits illumination light to illuminate the subject, and a switch including a first portion allowing no entry of the illumination light into the imaging unit and a second portion allowing entry of the illumination light into the imaging unit. The switch places one of the first portion or the second portion between the imaging unit and the opening based on a brightness of a surrounding environment.

The imaging device according to the above aspect of the present invention includes the light shield that covers the opening and the switch that switches between the state allowing entry of the illumination light into the imaging unit and the state allowing no entry of the illumination light into the imaging unit. The imaging device thus can perform imaging in a dark surrounding environment, while protecting the privacy of the subject.

### BRIEF DESCRIPTION OF DRAWINGS

FIGS. 1A and 1B are external perspective views of an imaging device according to an embodiment.

FIG. 2A is an internal plan view of the imaging device according to the embodiment, and

FIG. 2B is a cross-sectional view of the imaging device.

FIG. 3 is a block diagram of a control system for the imaging device according to the embodiment.

FIG. 4 is a flowchart of processing performed by the imaging device according to the embodiment in a low-light imaging mode.

### DETAILED DESCRIPTION

One or more embodiments of the present invention will now be described in detail with reference to the drawings.

An imaging device according to the present embodiment may be used for any purpose and may be installed, for example, at a hospital, a nursing care facility, a factory, and a store as a surveillance camera or a monitoring camera. The imaging device is switchable between an imaging state and an imaging-disabled state. More specifically, the imaging device can switch between a closed state in which light cannot enter an imaging optical system and an open state in which light can enter the imaging optical system. Once the imaging device is switched to the imaging-disabled state (closed state), a person being imaged can recognize that the imaging device has been switched to the imaging-disabled state. The imaging device is switchable between a normal imaging mode and a low-light imaging mode depending on the brightness of the surrounding external environment. The imaging in the normal imaging mode is performed using light incident on the imaging optical system when the external environment is bright. The imaging in the low-light imaging mode is performed using illumination light emitted when the external environment is dark to allow imaging of the subject using illumination light.

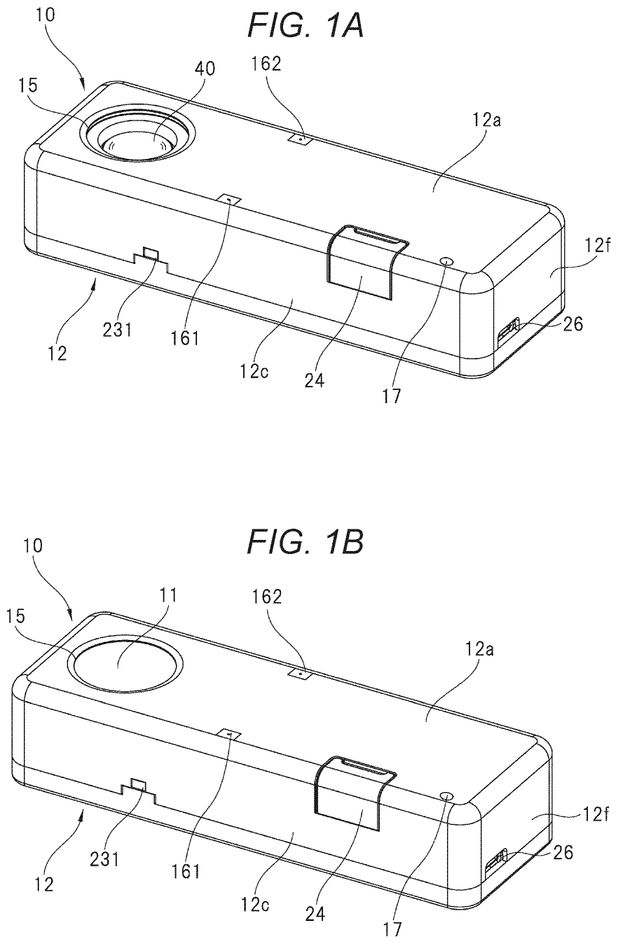

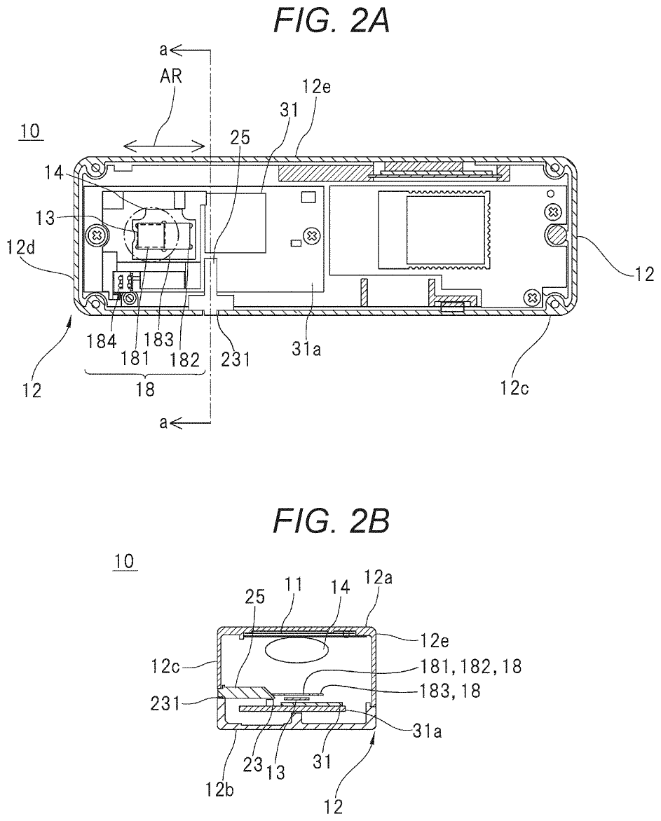

FIGS. 1A and 1B are external views of an imaging device 10. FIG. 1A is an external view of the imaging device 10 in the open state. FIG. 1B is an external view of the imaging device 10 in the closed state. FIG. 2A is an internal plan view of the imaging device 10. FIG. 2B is a cross-sectional view of the imaging device 10 taken along line a-a in FIG. 2A.

As shown in FIGS. 1A to 2B, the imaging device 10 includes a substantially rectangular housing 12. The housing 12 has a front surface 12a, a rear surface 12b, and side surfaces 12c, 12d, 12e, and 12f that meet the sides of the front surface 12a. Hereafter, the front surface 12a of the housing 12 is located upward, the rear surface 12b is located downward, the side surface 12c is located frontward, the side surface 12d is located leftward, and the side surface 12f is located rightward.

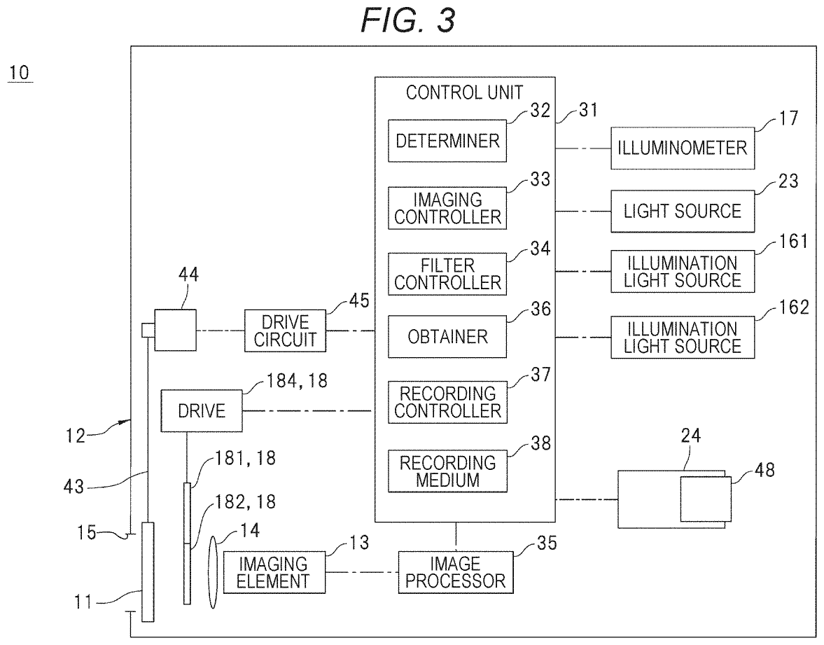

The housing 12 has a card slot 24 to receive a memory card 48 (refer to FIG. 3) and an opening 15 in the front surface 12a. The housing 12 also receives illumination light sources 161 and 162 and an illuminometer 17 on the front surface 12a. The side surface 12c has an outlet port 231 through which light from a light source 23 (described later) is output from the housing 12. The side surface 12d has a power port 26 to which a power cable is connected.

The illumination light sources 161 and 162 are, for example, light-emitting diodes (LEDs) that emit light with wavelengths in the infrared region (infrared rays or infrared light). In the low-light imaging mode (described later), the imaging device 10 emits infrared light from the illumination light sources 161 and 162 to illuminate the subject.

The illuminometer 17, which is, for example, a photoresistor or a photodiode, receives light from the surrounding environment (external environment) of the imaging device 10 and outputs a signal (luminance signal). In other words, the illuminometer 17 functions as a detector to detect the brightness outside the imaging device 10.

As shown in FIGS. 2A and 2B, the housing 12 in the imaging device 10 accommodates a lens cover 11, an imaging element 13 that is an image sensor such as a complementary metal-oxide semiconductor (CMOS) or a charge-coupled device (CCD), a lens 14 (imaging optical system) that focuses light from a subject (subject light) onto the imaging surface of the imaging element 13, a switch 18, a control unit 31, the light source 23, and a light guide 25. As shown in FIG. 2B, the lens cover 11, the imaging element 13, the lens 14, and the switch 18 are arranged parallel to the front surface 12a.

The opening 15 in the front surface 12a of the housing 12 is on the optical axis of the lens 14. Subject light passing through the opening 15 enters the imaging element 13 through the lens 14 (imaging optical system). The imaging element 13 receives subject light through the opening 15 in the housing 12 and outputs an image signal resulting from photoelectric conversion. An image processor 35 (refer to FIG. 3) described later subjects the output image signal to various types of processes to generate image data. More specifically, the imaging element 13 and the image processor 35 function as an imaging unit that receives subject light entering through the opening 15 in the housing 12 and generates image data.

The lens cover 11 is located along the optical axis of the lens 14 between the lens 14 and the opening 15 to open or close the opening 15. The lens cover 11 is movable to either an open position at which the opening 15 is open or a closed position at which the opening 15 is closed. The lens cover 11 moves on a plane orthogonal to the optical axis of the lens 14 (more specifically, a plane parallel to the front surface 12a). When the lens cover 11 moves to the open position, the lens cover 11 is away from the optical axis of the lens 14 to uncover the opening 15 on the optical axis of the lens 14 as shown in FIG. 1A (open state). This causes the lens 14 to be exposed through the opening 15 in the housing 12 to allow subject light to enter the imaging element 13 through the lens 14.

When the lens cover 11 moves to the closed position, the lens cover 11 closes the opening 15 in the housing 12 as shown in FIG. 1B (closed state). This causes the lens cover 11 to cover the lens 14 to protect the lens 14 in the housing 12. At the closed position shown in FIG. 1B, the lens cover 11 functions as a light shield to restrict subject light from entering the imaging element 13. The lens cover 11 is also referred to as a lens barrier or a shutter.

The switch 18 switches between the state in which no illumination light from the illumination light sources 161 and 162 is allowed to enter the imaging element 13 and the state in which illumination light is allowed to enter the imaging element 13 depending on the brightness (luminance) in the external environment of the imaging device 10. More specifically, the switch 18 includes a first filter 181, a second filter 182, a holder 183, and a drive 184. The first filter 181 is an infrared ray cut filter. The first filter 181 functions as a first portion that does not allow infrared light to enter the imaging element 13. The second filter 182 is, for example, a dummy lens, and functions as a second portion that allows infrared light to enter the imaging element 13.

The holder 183 includes a frame holding the first filter 181 and the second filter 182 on a plane parallel to the front surface 12a. The holder 183 is between the imaging element 13 and the lens 14 and is parallel to the imaging surface of the imaging element 13. The holder 183 is formed from, for example, a metal material. The holder 183 is thus strong enough to hold the first filter 181 and the second filter 182, without increasing its thickness in the optical axis direction of the lens 14.

The holder 183 holds the first filter 181 on the left and the second filter 182 on the right in the direction indicated by arrow AR shown in FIG. 2A. The holder 183 is movable in the direction indicated by arrow AR (more specifically, the direction in which the first filter 181 and the second filter 182 are held). As the holder 183 moves along arrow AR, either the first filter 181 or the second filter 182 is placed on the optical axis of the lens 14 (more specifically, between the imaging element 13 and the opening 15).

The drive 184 includes a drive, such as a stepping motor or a gear coupler, and a guide such as a lead screw. The drive 184 is thus connected to the holder 183. When the drive 184 is driven in response to a control signal from the control unit 31 (described below), the holder 183 connected to the drive 184 moves along the plane parallel to the front surface 12a in the direction indicated by arrow AR.

A substrate 31a is a base for holding the imaging element 13, the control unit 31, and the light source 23. The substrate 31a is installed on the rear surface 12b of the housing 12.

The control unit 31 includes a central processing unit (CPU), a memory, and other components. The control unit 31 is a processor that may read and execute a control program prerecorded in a recording medium 38 (refer to FIG. 3), such as a flash memory, to control various components of the imaging device 10. The processing performed by the control unit 31 will be described in detail later.

The light source 23 is, for example, an LED. The light source 23 emits indicator light to allow the user to recognize the operation of the imaging device 10 (e.g., during imaging) The light emitted from the light source 23 travels upward along the optical axis of the lens 14. The light guide 25 is formed from, for example, a transmissive material, such as glass or transparent resin. The indicator light emitted upward from the light source 23 is transmitted inside the light guide 25, while being guided to the outlet port 231 in the side surface 12c in the housing 12, and is output from the housing 12.

### Control System for Imaging Device 10

FIG. 3 is a block diagram of the control system for the imaging device 10. As shown in FIG. 3, the control unit 31 in the imaging device 10 includes a determiner 32, an imaging controller 33, a filter controller 34, an obtainer 36, a recording controller 37, and a recording medium 38.

The determiner 32 determines whether the external environment of the imaging device 10 is bright or dark based on a luminance signal output from the illuminometer 17.

The imaging controller 33 controls driving of the imaging element 13 to cause the imaging element 13 to generate an image signal. The imaging controller 33 then performs an imaging process that causes the image processor 35 to generate image data based on the image signal. In capturing an image in the low-light imaging mode (described later), the imaging controller 33 supplies power to the illumination light sources 161 and 162 to cause infrared light to be output as illumination light.

Based on a determination result from the determiner 32, the filter controller 34 controls movement of the holder 183 by driving the drive 184 to place the first filter 181 or the second filter 182 on the optical axis of the lens 14. In this case, the filter controller 34 places the first filter 181 that is an infrared ray cut filter on the optical axis of the lens 14 in the normal imaging mode, and places the second filter 182 that is a dummy lens on the optical axis of the lens 14 in the low-light imaging mode.

The obtainer 36 performs an obtaining process to obtain an amplification factor used by the image processor 35 in switching to the low-light imaging mode (more specifically, when the external environment surrounding the imaging device 10 is dark) when the lens cover 11 is at the closed position to cover the opening 15.

The recording controller 37 performs a recording process to record image data generated by the image processor 35 into the memory card 48.

A link assembly 43 connects the lens cover 11 that opens or closes the opening 15 to an actuator 44. The actuator 44 is connected to a drive circuit 45. The drive circuit 45 is connected to the control unit 31 to drive the actuator 44 in response to a control signal (drive signal) from the control unit 31.

### Processing Performed by Control Unit 31

The imaging device 10 starts capturing an image when the imaging condition is satisfied. The imaging condition includes a wireless tag, such as an integrated circuit (IC) tag, approaching a predetermined range. In this case, the control unit 31 determines whether a person carrying a wireless tag has entered a predetermined imaging area based on the intensity of a received signal with a radio communication module (not shown) connected to the control unit 31. When the intensity of the received signal exceeds a predetermined threshold Xa, the control unit 31 determines that the person has entered the imaging area, or in other words, the imaging condition is satisfied.

The imaging condition may include, for example, receiving a recording signal transmitted from a mobile terminal such as a smartphone, receiving an infrared ray transmitted from a remote control, or detecting a voice with predetermined information with a microphone (not shown).

When the imaging condition is satisfied, the imaging device 10 moves the lens cover 11 from the closed position to the open position for capturing an image of the subject. More specifically, the control unit 31 drives the drive circuit 45 to drive the actuator 44 that then moves the lens cover 11 to the open position with the link assembly 43. The imaging element 13 receives subject light entering through the opening 15 and outputs an image signal to the image processor 35. The image processor 35 is an image signal processor (ISP). The image processor 35 subjects the image signal output from the imaging element 13 to known image processes, such as an analog-to-digital (AD) conversion process, a signal amplification process, and a white balance process, and generates image data. The image processor 35 controls the amplification factor for the image signal based on the generated image data with auto gain control (AGC) in both the normal imaging mode and the low-light imaging mode.

A determination process is performed by the determiner 32. In this case, the determiner 32 calculates the luminance value based on a luminance signal output from the illuminometer 17, and determines that the external environment is bright in response to the value exceeding a predetermined threshold and determines that the external environment is dark in response to the value being less than or equal to the threshold. The predetermined threshold is set based on the results of testing or simulations, and is prerecorded in the recording medium 38.

When the luminance value exceeds the threshold and the surrounding external environment is determined to be bright, the imaging device 10 performs imaging in the normal imaging mode. When the luminance value is less than or equal to the threshold and the surrounding external environment is determined to be dark, the imaging device 10 performs imaging in the low-light imaging mode.

When the imaging condition is no longer satisfied, the control unit 31 causes the drive circuit 45 to drive the actuator 44 to move the lens cover 11 to the closed position with the link assembly 43. When the lens cover 11 is at the closed position and the imaging device 10 is in the closed state, the obtainer 36 in the control unit 31 performs the obtaining process. Normal Imaging Mode

In the normal imaging mode, the filter controller 34 controls the drive 184 to position the first filter 181 on the optical axis of the lens 14. Without infrared light being incident, the imaging element 13 outputs an image signal resulting from photoelectric conversion. The image processor 35 generates image data using the image signal.

### Low-Light Imaging Mode

In the low-light imaging mode, the imaging device 10 applies infrared light as illumination light when the external environment is dark and lacks a sufficient amount of light, and captures an image of the subject illuminated with the infrared light. When the determiner 32 determines that the external environment is dark and the imaging is to be performed in the low-light imaging mode, the imaging controller 33 reads setting data obtained from the recording medium 38 through the obtaining process (described late), and sets the amplification factor to be used in generating image data. The filter controller 34 controls the drive 184 to move the first filter 181 off the optical axis of the lens 14 and place the second filter 182 on the optical axis of the lens 14. This allows infrared light to enter the imaging element 13. The imaging controller 33 then emits infrared light as illumination light from the illumination light sources 161 and 162 as described above.

When the imaging device 10 switches from the closed state to the low-light imaging mode, the control unit 31 moves the lens cover 11 to the open position and uncovers the opening 15 after the value of the setting data is set as the amplification factor. This allows the illumination light sources 161 and 162 to emit illumination light. The illumination light from the illumination light sources 161 and 162 is emitted after the second filter 182 is placed on the optical axis of the lens 14 by the filter controller 34. More specifically, the second filter 182 is placed either before or after the lens cover 11 is open.

With the second filter 182 on the optical axis of the lens 14, the imaging element 13 receives light emitted from the illumination light sources 161 and 162 and reflected from the subject, and outputs an image signal. The image processor 35 generates image data using the image signal. The imaging controller 33 causes the image processor 35 to generate image data by amplifying the image signal at the amplification factor set to the value of the setting data read from the recording medium 38. Thus, the amplification factor for imaging in the low-light imaging mode can be set in a shorter time than when the amplification factor is controlled with AGC, thus reducing a delay before the imaging is started in the low-light imaging mode. After the imaging in the low-light imaging mode is started, the imaging controller 33 sets a new amplification factor calculated with AGC to be used by the image processor 35 for generating image data.

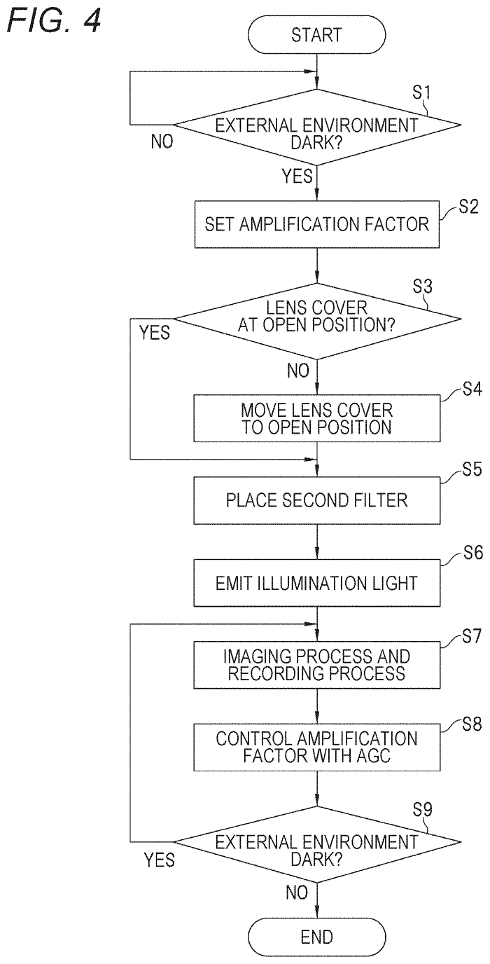

With reference to a flowchart in FIG. 4, the processing performed by the control unit 31 in the low-light imaging mode will be described. The control unit 31 reads and executes a program recorded in the recording medium 38 to perform the processing in the flowchart.

In step S1, the determination is performed as to whether the external environment of the imaging device 10 is dark. When the luminance value calculated based on the luminance signal output from the illuminometer 17 is less than or equal to the threshold, the determiner 32 determines that the external environment is dark and the processing advances to step S2. When the luminance value exceeds the threshold, the determiner 32 determines that the external environment is bright and the determination in step S1 is repeated.

In step S2, the imaging controller 33 sets the value of the setting data recorded in the recording medium 38 as the amplification factor to be used by the image processor 35 in generating image data. The processing then advances to step S3.

In step S3, the control unit 31 determines whether the lens cover 11 is at the closed position or at the open position. When the lens cover 11 is at the closed position (specifically, the imaging device 10 is in the closed state), the processing advances to step S4. When the lens cover 11 is at the open position (specifically, the imaging device 10 is in the open state), the processing advances to step S5 by skipping step S4.

In step S4, the control unit 31 causes the drive circuit 45 to drive the actuator 44 to move the lens cover 11 to the open position with the link assembly 43. The processing then advances to step S5. In step S5, the filter controller 34 controls the drive 184 to move the holder 183 and place the second filter 182 on the optical axis of the lens 14. When the second filter 182 is on the optical axis of the lens 14 with the imaging device 10 being at the open position, the processing in step S5 may be skipped. The processing then advances to step S6. The determination as to whether the second filter 182 is on the optical axis of the lens 14 is performed using a sensor such as a photo-interrupter (not shown) or a photo reflector.

In step S6, the imaging controller 33 emits infrared light as illumination light from the illumination light sources 161 and 162 as described above. The processing then advances to step S7. In step S7, the imaging controller 33 causes the imaging element 13 and the image processor 35 to generate image data (imaging process), and the recording controller 37 records the generated image data into the memory card 48 (recording process). The processing then advances to step S8.

In step S8, the imaging controller 33 calculates a new amplification factor based on the image data generated by the image processor 35 with AGC. The imaging controller 33 then sets the calculated new amplification factor to be used by the image processor 35 in generating image data. The processing then advances to step S9. In step S9, the determination is performed as to whether the external environment of the imaging device 10 is dark in the same manner as in step S1. When the external environment of the imaging device 10 is dark, the processing in step S9 results in affirmative determination, and the processing returns to step S7. When the external environment of the imaging device 10 is bright, the processing in step S9 results in negative determination, and the processing in the low-light imaging mode ends. To end the processing in the low-light imaging mode, the imaging controller 33 also stops the emission of illumination light from the illumination light sources 161 and 162, and the filter controller 34 controls the drive 184 to move the holder 183 and place the first filter 181 on the optical axis of the lens 14.

### Obtaining Process

The imaging controller 33 controls the amplification factor for an image signal based on generated image data with AGC. In the low-light imaging mode in which the external environment of the imaging device 10 is dark or when the lens cover 11 is at the closed position, a small amount of light enters the imaging element 13. When the imaging device 10 performs imaging in the normal imaging mode, the amount of light entering the imaging element 13 is greater than when performing imaging in the low-light imaging mode. Thus, when controlling the amplification factor for an image signal with AGC, the imaging controller 33 sets a greater amplification factor for the imaging device 10 performing imaging in the low-light imaging mode than for the imaging device 10 performing imaging in the normal imaging mode.

For the imaging device 10 switching to the low-light imaging mode, however, setting the amplification factor with AGC can take time and can cause a delay before the imaging in the low-light imaging mode is started. To reduce such a delay, the imaging controller 33 sets the amplification factor to be used by the image processor 35 in generating image data to a predetermined amplification factor when the imaging mode is switched to the low-light imaging mode. The predetermined amplification factor is the setting data described above and is obtained by the obtainer 36 performing the obtaining process.

When the lens cover 11 is at the closed position, a small amount of light enters the imaging element 13 as in the low-light imaging mode, as described above. Thus, the obtainer 36 obtains the amplification factor controlled with AGC after the lens cover 11 is placed at the closed position. The obtainer 36 records the obtained amplification factor as setting data into the recording medium 38. The obtaining process may be performed before the imaging device 10 is shipped, or may be performed every time the lens cover 11 is at the closed position or every time the lens cover 11 is moved to the closed position a predetermined number of times.

The recording medium 38 may further record correction data, in addition to the setting data described above. The correction data is set in accordance with the darkness (specifically, the luminance level detected by the illuminometer 17) of a different external environment. In this case, the obtainer 36 first obtains the luminance value calculated based on a luminance signal output from the illuminometer 17. Based on the darkness of the external environment, the obtainer 36 obtains the amplification factor controlled with AGC when the lens cover 11 is at the closed position (first amplification factor) and the amplification factor controlled with AGC when the lens cover 11 is at the open position (second amplification factor). The obtainer 36 then calculates the difference between the first amplification factor and the second amplification factor as correction data. This correction data is recorded into the recording medium 38 in a manner associated with the luminance values corresponding to when the first amplification factor and the second amplification factor are obtained. The correction data is obtained and calculated for each predetermined luminance value and is recorded into the recording medium 38.

The imaging controller 33 sets the value corrected with the correction data for the setting data as the amplification factor when switching to the low-light imaging mode. In this case, the imaging controller 33 reads the correction data associated with the luminance value from the recording medium 38 based on the luminance value detected by the illuminometer 17 when switching to the low-light imaging mode. The imaging controller 33 sets the amplification factor used in the low-light imaging mode to the value obtained by correcting the setting data using the read correction data. The amplification factor can thus be set in accordance with the degree of darkness of the external environment in switching to the low-light imaging mode, allowing the setting of the imaging sensitivity for the dark external environment while reducing the delay in starting the imaging in the low-light imaging mode.

In the obtaining process described above, the first filter 181 may be placed on the optical axis of the lens 14, and the second filter 182 may be placed on the optical axis of the lens 14.

The structure according to the above embodiment produces the advantageous effects described below.

(1) The imaging device 10 includes the lens cover 11, the illumination light sources 161 and 162 that emit illumination light, and the switch 18. The lens cover 11 is between the opening 15 and the imaging element 13 and covers the opening 15 to restrict subject light from entering the imaging element 13. The switch 18 includes the first filter 181 that allows no entry of illumination light into the imaging element 13 and the second filter 182 that allows entry of illumination light into the imaging element 13. The switch 18 places one of the first filter 181 or the second filter 182 between the imaging element 13 and the opening 15 based on the brightness of the surrounding environment. This structure allows the imaging device 10 as a surveillance camera to perform imaging in the low-light imaging mode when the external environment is dark, while protecting the privacy of the subject with the lens cover 11.

The holder 183 has a small thickness along the optical axis of the lens 14. The first filter 181 and the second filter 182 held by the holder 183 move in a plane parallel to the front surface 12a. Thus, the switch 18 accommodated in the housing 12 is less likely to affect the size of the housing 12 in the optical axis direction of the lens 14, and reduces upsizing of the imaging device 10.

(2) The obtainer 36 obtains the amplification factor for a signal used by the image processor 35 to generate image data with the opening 15 being covered with the lens cover 11. The amplification factor for imaging in the low-light imaging mode can be obtained as setting data in a pseudo environment simulating the imaging performed in the low-light imaging mode in a dark external environment.

(3) In response to determination that the brightness detected by the illuminometer 17 is less than the threshold, the imaging controller 33 causes the image processor 35 to generate image data after setting the amplification factor for a signal used to generate image data to the amplification factor obtained by the obtainer 36. The setting data can thus be set to the amplification factor in switching to the low-light imaging mode. The amplification factor for the low-light imaging mode can be set in a shorter time than when the amplification factor is set with AGC. The imaging device 10 can thus avoid failing to serve as a surveillance camera when the lens cover 11 is open for imaging in the low-light imaging mode.

(4) In response to determination that the brightness detected by the illuminometer 17 is less than the threshold with the opening 15 being covered with the lens cover 11, the drive circuit 45 drives the lens cover 11 to uncover the opening 15 after the imaging controller 33 sets the amplification factor to the value of the setting data. The illumination light sources 161 and 162 emit illumination light after the opening 15 is open. The illumination light is emitted after the imaging element 13 receives infrared light and the image processor 35 is prepared to generate image data with the amplification factor for the low-light imaging mode. This prevents imaging from being performed with an amplification factor unsuited for the low-light imaging mode.

(5) The imaging controller 33 sets the amplification factor used by the image processor 35 to generate image data based on the image data generated in response to the image signal output from the imaging element 13 receiving illumination light. This allows the imaging device 10 to switch from generating image data using setting data as the amplification factor to generating image data using the amplification factor obtained with AGC by actually capturing an image of a subject illuminated with the illumination light. The imaging device 10 can thus switch to the low-light imaging mode with a small delay using the setting data as the amplification factor. The imaging device 10 can thus generate an image with higher quality using the amplification factor for the subject illuminated with the illumination light after switching to the low-light imaging mode.

(6) After the switch 18 places the second filter 182 between the imaging element 13 and the opening 15, the illumination light sources 161 and 162 emit illumination light. The first filter 181 can avoid allowing no entry of infrared light into the imaging element 13 and disabling imaging after the camera is switched to the low-light imaging mode.

Although various embodiments and modifications are described above, the present invention is not limited to the embodiments and the modifications. Other forms implementable within the scope of technical idea of the present invention fall within the scope of the present invention.

In the processing in the flowchart in FIG. 4 described above, the processing in steps S3 and S4 may not be performed. More specifically, in the processing performed by the control unit 31 in the low-light imaging mode, the process for opening and closing the lens cover 11 may be a separate, independent process. In this case, for example, the opening and closing of the lens cover 11 is controlled by receiving a cover control signal transmitted from a mobile terminal or another device, receiving an infrared ray transmitted from a remote control or another device, or detecting a voice with predetermined information with a microphone (not shown).

What is claimed is:

1. An imaging device, comprising:
an imaging unit configured to receive subject light from a subject passing through an opening, convert the subject light to an image signal, and amplify the image signal to generate image data;
a light shield between the opening and the imaging unit, the light shield being configured to cover the opening to restrict the subject light from entering the imaging unit;
an illumination light source configured to emit illumination light to illuminate the subject; and
a switch including a first portion allowing no entry of the illumination light into the imaging unit and a second portion allowing entry of the illumination light into the imaging unit, the switch being configured to place one of the first portion or the second portion between the imaging unit and the opening based on a brightness of a surrounding environment.

2. The imaging device according to claim 1, further comprising:
an obtainer configured to obtain an amplification factor for generating the image data with the opening being covered with the light shield.

3. The imaging device according to claim 2, wherein
the obtainer obtains the amplification factor with the first portion located between the light shield and the imaging unit.

4. The imaging device according to claim 2, wherein
the obtainer obtains the amplification factor with the second portion located between the light shield and the imaging unit.

5. The imaging device according to claim 2, further comprising:
a detector configured to detect an external brightness; and
an imaging controller configured to set, in response to the external brightness detected by the detector being less than a threshold, an amplification factor for the imaging unit to generate the image data to the amplification factor obtained by the obtainer, and then cause the imaging unit to generate the image data.

6. The imaging device according to claim 5, further comprising:
a drive configured to drive, in response to the external brightness detected by the detector being less than the threshold with the opening being covered with the light shield, the light shield to uncover the opening after the imaging controller sets the amplification factor for the imaging unit,
wherein the illumination light source emits the illumination light after the light shield uncovers the opening.

7. The imaging device according to claim 6, wherein
the imaging controller calculates a new amplification factor based on the image data generated by the imaging unit receiving the illumination light, and
the imaging unit generates the image data using the calculated new amplification factor.

8. The imaging device according to claim 1, wherein
the illumination light source emits the illumination light after the switch places the second portion between the imaging unit and the opening.
